(19) United States
(12) Patent Application Publication
(10) Pub. No.: US 2004/0081450 A1
(43) Pub. Date: Apr. 29, 2004

(54) Timer for hands free activation of manual device

(76) Inventors: Greg T. Joy, Lafayette, CA (US); Douglas Gibbs, Yuba City, CA (US)

Correspondence Address: Leigh Hunt Firestone, 7100 Norfolk Road, Berkeley, CA, 94705, US

(21) Appl. No.: 10/436,186

(22) Filed: May 12, 2003

Related U.S. Application Data
(60) Provisional application No. 60/421,841, filed on Oct. 29, 2002.

(51) Int. Cl. G03B 17/38

(52) U.S. Cl. 396/502

(57) ABSTRACT

The invention is directed to an attachable timer for hands free activation of a camera or like device. The timer is attachable to a camera or other device generally requiring manual activation. The timer can be used in conjunction with a planar base that holds the camera and with also with a tripod connected to the base or the camera for stabilizing or positioning the timer-plus-camera combination for the best possible remotely activated shots. Many different attachment types can attach the timer to the camera.

### PARENT REFERENCE

This application claims the benefit of the filing date of application Ser. No. 60/421,841, filed Oct. 29, 2002 that remains pending and which is expressly incorporated by reference in its entirety.

### FIELD OF THE INVENTION

The present invention relates to adjunct devices for cameras and VCRs, particularly devices that are portable, lightweight and directed towards increasing the use and function of the original camera or VCR.

### BACKGROUND OF THE INVENTION

Many photographic devices in current use are manually operated without the option for delayed activation. Such devices typically include disposable or single-use cameras and some less expensive cameras having only manual activation without a timer function. Of these manual activation only cameras, some are digital cameras and some are cameras using standard film. Also, often sold without a timer function are VCRs that record and display moving pictures using either voice and visual recording tape or digitally stored information.

U.S. Pat. No. 6,488,420 describes a tripod-mounted housing having a fulcrum-operated timer. This invention requires that the camera fit in the housing. Additionally, U.S. Pat. No. 6,488,420 describes a housing with the timer attached to the housing so that a fulcrum (also called spring loaded lever) can act on the trigger with the stabilizing support of the housing. As U.S. Pat. No. 6,488,420 includes a housing the invention is limited to use with devices that fit within the confines of the designated housing. In addition, the fulcrum-operated timer requires mounting to the housing for stabilizing the fulcrum action on the trigger, and thus the usefulness and adaptability of the timer is limited by its permanent attachment to the housing.

It would be advantageous to design a timer that can be used with any manual photographic or video device having a trigger, such that the timer does not require a housing or base in order to attach to the device and activate the device trigger. Accordingly, the inventors have developed such a hands free re-usable timer for the purpose described.

### SUMMARY OF THE INVENTION

In one aspect, the invention includes a timer for hands-free activation of a device having a trigger that otherwise requires manual activation comprising:

a. a mechanical unit connected to a spring, said unit having a rotation cycle that compresses said spring generating a rotational potential,

b. an activation pin in said mechanical unit for receiving said rotational potential and translating said potential into a vertical movement of said pin to strike said trigger on said device upon completion of said rotation cycle, and

c. an attachment modality for temporary attachment of the timer to a portion of said device comprising said trigger so that a pin end rests above said trigger prior to completion of said rotation cycle.

The invention further comprises a timer for hands-free activation of a device having a trigger that otherwise requires manual activation comprising:

a. a mechanical unit connected to a spring, said unit having a rotation cycle in a range from about 30 to about 1000 rotation degrees that compresses said spring generating a rotational potential,

b. an activation pin in said mechanical unit for receiving said rotational potential and translating said potential into a vertical movement of said pin to strike said trigger on said device with a pin end upon completion of said rotation cycle, and

c. Velcro™ attachment straps for temporary attachment of said timer to a portion of said device so that said pin end rests just above said trigger prior to completion of said rotation cycle.

wherein said rotation cycle of said mechanical unit rotates in a plane parallel to a plane of the device having the trigger.

The invention additionally comprises a timer for hands-free activation of a device having a trigger that otherwise requires manual activation comprising:

a. a mechanical unit connected to a spring, said unit having a rotation cycle in a range from about 30 to about 1000 rotation degrees that compresses said spring generating a rotational potential,

b. an activation pin in said mechanical unit for receiving said rotational potential and translating said potential into a vertical movement of said pin to strike said trigger on said device with a pin end upon completion of said rotation cycle, and

c. Velcro™ attachment straps for temporary attachment of the timer to a portion of said device so that said pin end rests just above said trigger prior to completion of said rotation cycle.

wherein said rotation cycle of said mechanical unit rotates in a plane perpendicular to a plane of the device having the trigger.

The invention also comprises a camera and timer combination comprising a camera having a housing with a top and a bottom, said top having a shutter trigger, wherein said top of said housing comprises a snap-on or clamp-on connection; comprising also a timer having a top and a bottom, said top having a mechanical unit for hands free activation of a camera shutter trigger, said bottom comprising a partner for said snap-on or clamp-on connection on said camera.

Finally, the invention further includes a timer for hands-free activation of a device having a trigger that otherwise requires manual activation comprising:

a. a mechanical unit connected to a spring, said unit having a rotation cycle that compresses said spring generating a rotational potential,

b. an activation pin in said mechanical unit for receiving said rotational potential and translating said potential into a vertical movement of said pin to strike said trigger on said device upon completion of said rotation cycle, and

c. a base unit having an attachment modality for temporary attachment of the timer to a portion of said device comprising said trigger so that a pin end rests above said trigger prior to completion of said rotation cycle, wherein said base unit is attachable to said mechanical unit and receives said pin.

### BRIEF DESCRIPTION OF THE FIGURES

FIG. 1 depicts one type of standard tripod with bendable legs, round feet, and a threaded portion for receiving a base or camera.

FIG. 2 depicts a planar base and high friction planar sections, the planar base having wing like cutout attachment portions for strapping the base to the camera.

FIG. 3 depicts a belt or Velcro™ strap.

FIG. 4 depicts a prototype timer having a wind up mechanism that is perpendicular to the plane of the device's trigger.

FIG. 5 depicts a prototype timer having a wind up mechanism that is parallel to the plane of the device's trigger.

FIG. 6 depicts a camera mounted on a base that is attached to a tripod, the camera having the timer strapped around it with the straps going through the cut out wing-like attachments.

FIG. 7 depicts a camera without a base or tripod having the timer strapped to it for time-delayed remote activation of the camera shutter by winding up the timer.

FIG. 8 depicts a camera having a timer that attaches to the camera housing through a slide-on track.

FIG. 9 depicts a camera having a pivot-rotating attachment to attach the timer to the camera housing.

FIG. 10 depicts a camera having a thread-on attachment for screwing the timer onto the camera housing.

FIG. 11 depicts a camera having a slide-on trough-like attachment for attaching the timer to the camera housing.

FIG. 12 depicts a retractable hidden attachment lodged in the camera housing for holding the timer in place when the timer is in use.

FIG. 13 depicts a camera having a base unit for receiving the timer, the base unit configured to receive and hold the timer in place while it operates to take the picture.

### DETAILED DESCRIPTION OF THE INVENTION

The present application incorporates by reference in its entirety the parent provisional U.S. S No. 60/421,841, filed Oct. 29, 2002 that is referenced herein for the substantive and express reference of its entire disclosure including the figures.

The inventors have developed a timer for hands free activation of a manual device. Elements and function of the timer in the context of its use for hands free activation of a manual device are best developed by elaboration of the figures.

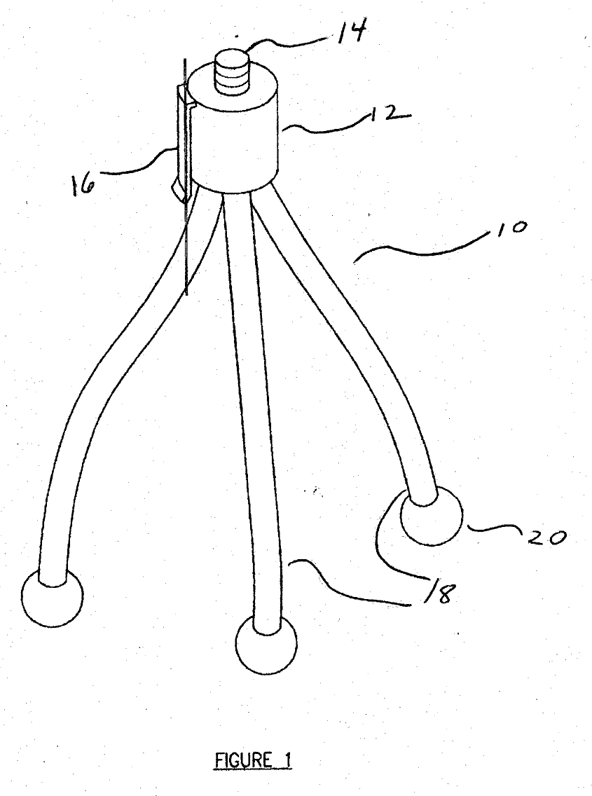

Turning now to the figures, FIG. 1 depicts one type of standard tripod (10) with bendable legs (18), round feet (20), and a threaded portion for receiving a base or camera (14), as well as a hub (12) for the legs and a clip (16) on the hub for attachment as necessary to anchor items or for carrying when not in use. The tripod (10) can form a receiving unit for a base or camera having the timer attached so that the device to which the timer is attached is stabilized and positioned property for taking a picture of the subject. The bendable legs (18) are adjustable upon any surface in order to position the camera lens optimally at the subject.

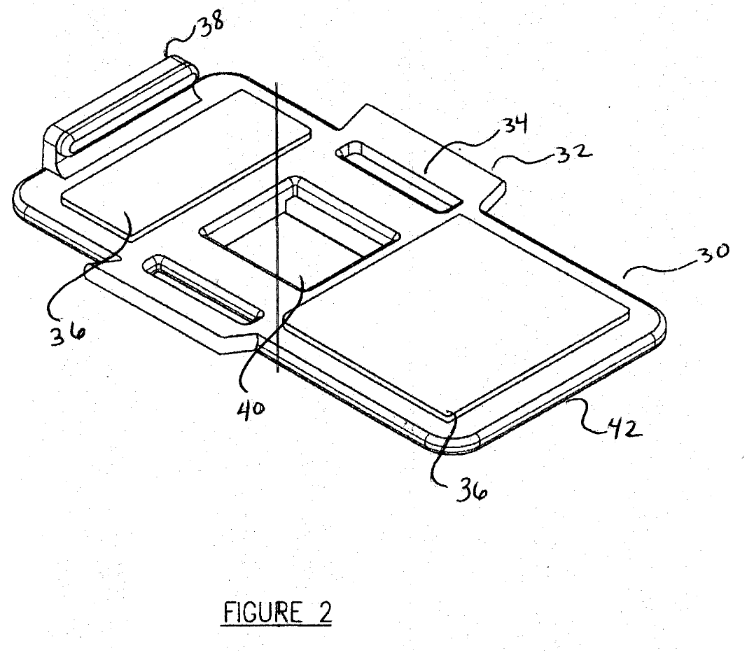

FIG. 2 depicts a planar base (30) having high friction planar sections (36). The high friction planar sections can be made of rubber or any synthetic material that, upon being contacted with the base of a device (such as, for example, a metal or plastic camera), tends to grip the base of the device and prevent it from sliding off the base. The high friction planar sections can further have ridges or striations that further grip the device. Though not essential, the planar base can have wing like attachment portions (32) that fan out from the planar base. The wing like attachment portions can fan out above or below the plane (as depicted) or they can fan out in-line with the plane of the base (30). The wing like attachment portions (32) can further comprise cutout sections (34) for providing a through unit for strapping the base to the device that requires a timer. The planar base (30) is useful when a tripod is employed with the camera to position the camera for the shot to be taken. Tripod attachment portion can be located at position (40) for attachment to the base, e.g. by screwing or snapping the base into the tripod. The planar base (30) receives the device to which the timer is attached using the high friction planar sections (36) to grip the bottom of the device with fidelity. The planar base (30) can be used with the device in the absence of the tripod. However, it can be useful to attach the device to a tripod where conditions warrant use of a tripod. The base is designed to work either way. The base generally functions to support the device to which the timer is attached so that it can be placed on a ledge or wall for taking the picture. Additionally, the planar base (30) can optionally have a side support (38) at one end for additional stabilization of a device that rests on the base, for example in a case where the bottom of the device exceeds the parameters of the planar base (30) and extends over the side (42).

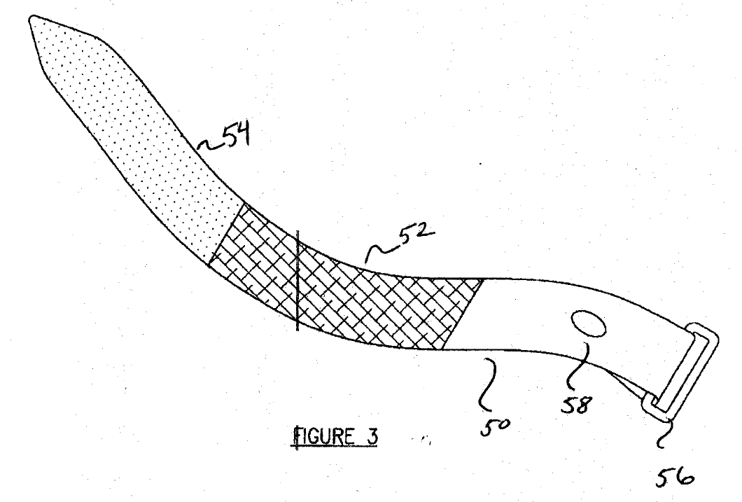

FIG. 3 depicts a strap (50) having a grabbing section (52) and a receiving section (54). When the grabbing section (52) and the receiving section (54) contact each other they stick together. Thus the strap can be made, for example, of Velcro™, or any two materials that when in contact form a temporary bond. The strap (50) connects to the timer and wraps around the device to which the timer is to be attached holding the timer to the device, over the trigger on the device. The strap connects to itself to form the hold. The main function of the strap (50) is to hold the timer to the device. A secondary function of the strap (50) is to hold the timer to the device and to the base, e.g. where the base comprises wing like attachment portions (32) having cutout sections (34) for providing a through unit for strapping the device to the base.

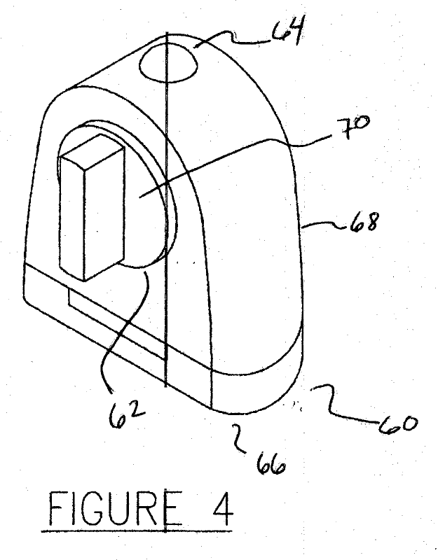

FIG. 4 depicts a prototype timer (60) having a wind-up mechanism (62) that is perpendicular to the plane (66) of the device's trigger. The wind-up mechanism (62) rotates manually to wind-up, compressing a spring housed in the mechanism (but not depicted in the figure). The pin is positioned at spot (64) where it extends through the mechanical unit having the wind-up mechanism (62). In this configuration the plane of the wind-up mechanism (62) is perpendicular to the plane of the device trigger that exists at plane (66). The mechanism (62) is wound by dial (70) in a rotation cycle in a range from 30 degrees to 1000 degrees, also a range from 50 degrees to 500 degrees, and possibly also at a range from 60 degrees to 360 degrees rotation. Depending on the time desired before activation of the trigger, and wind-up amount can increase or decrease. The wind-up amount can be designated by a single fixed time, e.g. 10 seconds or 20 seconds, etc.; several different times (e.g. the option to set the timer at 10 seconds, or at a minute, depending on how much time the person (who is going to be in the picture) needs in order to set the camera and get into the shot.

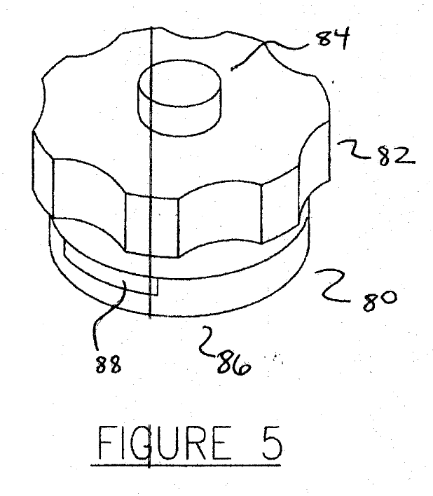

FIG. 5 depicts a prototype timer (80) having a wind-up mechanical unit (82) that is parallel to the plane (86) of the device's trigger. Pin (84) is perpendicular to the plane (86) of the device's trigger. The timer has slat (88) for threading a strap or the like through in order to strap the timer onto the device requiring timer activation. The mechanical unit (82) is wound in the range from about 30 to about 1000 rotational degrees, also in a range from about 50 to 500 rotational degrees, or in a range from about 60 to about 360 rotational degrees. The amount of rotational degrees generally indicates the amount of time before the timer activates the device trigger. For example, 355 degrees may indicate about 10 seconds and 1000 degrees may indicate about 30 seconds before the timer is activated to release the pin and open the camera shutter. The mechanical unit (82) may have a fixed rotational cycle, or it may be variable or adjustable. Thus, for example, the mechanical unit (82) having button (84) may be set on 10 seconds, 20 seconds or 30 seconds, or it may have the option for the user to select one of these three settings for any particular shot, depending on how long the user estimates it will take him or her to get into the shot. The timer (80) may also have complete variability in the setting of the timer thus providing ultimate flexibility to the user. So, for example, the user can set the timer (80) at anywhere from 1000 degrees of rotation down to 30 degrees of rotation. Upon completion of the rotation cycle, the timer (80) releases a pin (not specifically pictured) to contact the device trigger at plane (86) above which the timer (80) rests. To set the timer (80), the mechanical windup unit (82) is wound to a stopping point and button (84) is depressed which starts the rotation cycle. The rotation cycle ends in a release of the pin onto the trigger of the target device.

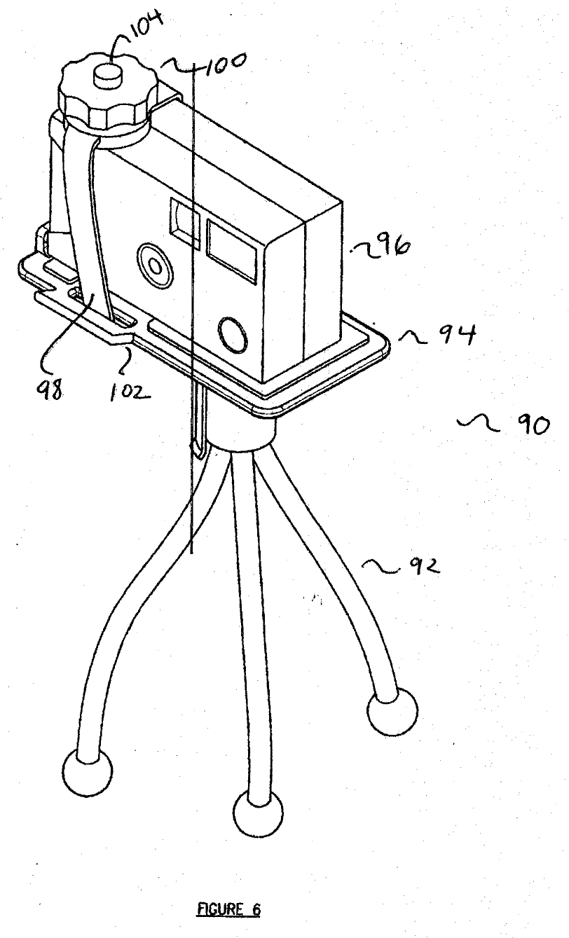

FIG. 6 depicts an assembly (90) comprising three components: the tripod (92), the base (94) and the timer (100). The timer (100) having button (104) is strapped to the device (96) depicted here as a camera. Straps (98) hold the timer (100) over the trigger of the device (96) by attachment through the wing-like attachment portions having cutouts (102) for threading the strap to secure the camera to the base (94). The tripod (92) can be attached to the underside of base (94). Camera (96) can be placed through strap (98) at top of base (94). Timer (100) is placed over camera button. Strap (98) is pulled down to secure camera (96) tightly to base (94). Timer (100) is twisted clockwise until it stops. The camera (96) is positioned as desired for the shot. The button (104) on timer (100) is pushed and the rotation cycle begins. The picture is taken within about 10 to 12 seconds.

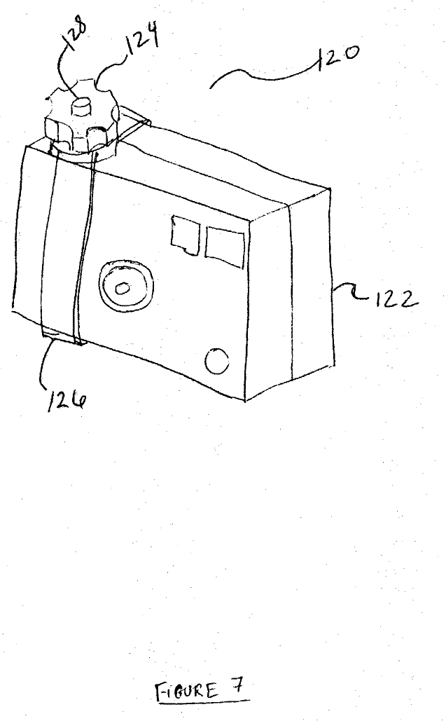

FIG. 7 depicts a device having a hands-free timer attached (120) with the timer (124) attached by strap (126) to camera (122). Timer (124) is positioned over the camera trigger for activating the pin (128) to contact the trigger below it. Similar variable degrees of rotation can be provided in the mechanical unit of the timer (120) as described for FIG. 5.

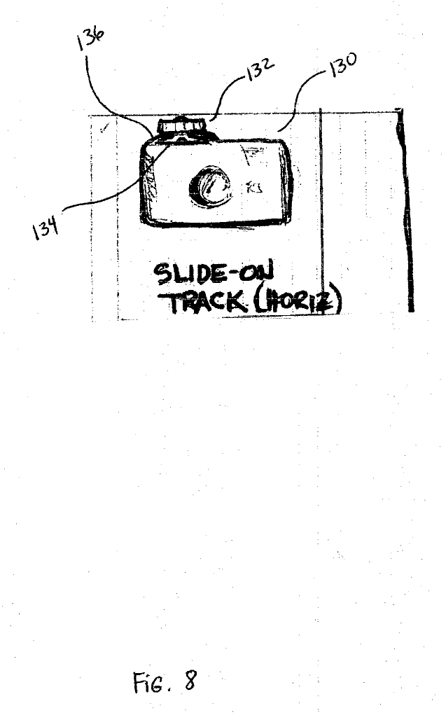

FIG. 8 depicts camera (130) having a timer mechanism (132) with a neck (134) for slide-on attachment to the trough (136) having a timer that attaches to the camera housing through a slide-on track (136).

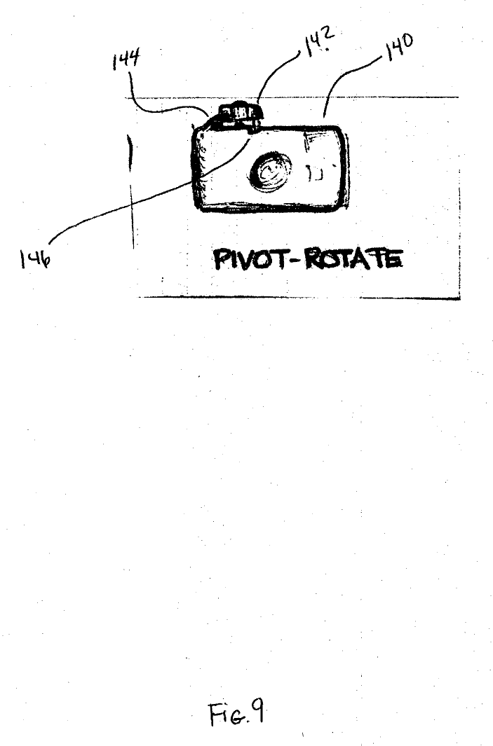

FIG. 9 depicts camera (140) having a timer mechanism (142) that pivots from arm (144) to lodge in well (146) for positioning the timer (142) over the shutter button (not shown) to align the activation pin over the shutter button for opening the shutter when the mechanical timer winds down.

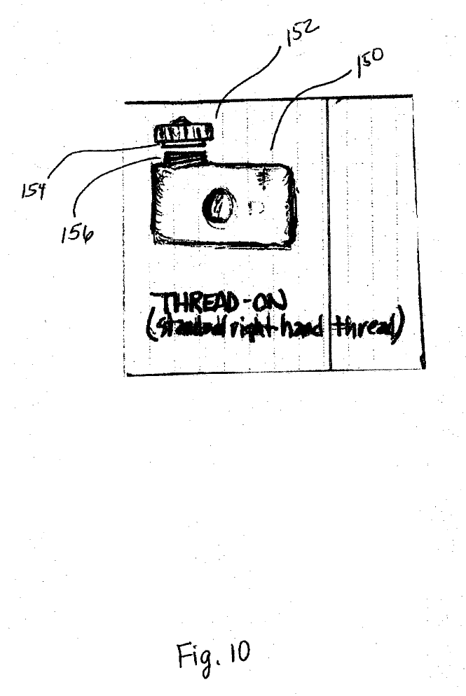

FIG. 10 depicts camera (150) having timer (152) with threaded attachment 154 for screwing onto camera housing threads (156) for positioning the timer over the shutter button. The threads can be right hand, which is standard, or non-standard threads depending on the specific needs of the timer unit and camera.

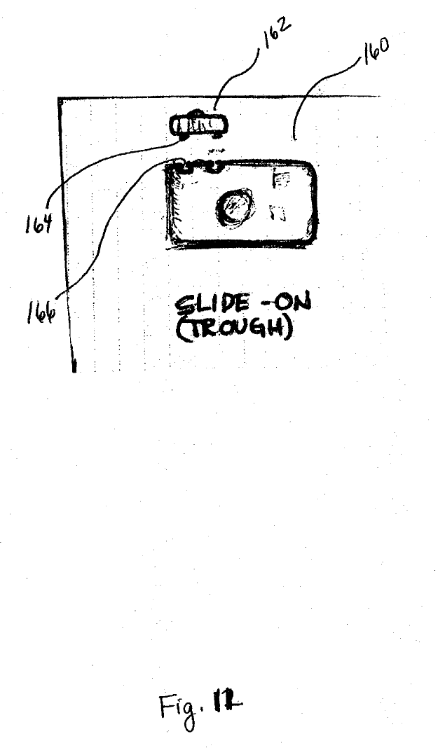

FIG. 11 depicts camera (160) having timer (162) with trough nubbins (164) for running the timer into troughs (166) on the camera housing for attaching the timer to the camera housing at a position directly above the shutter button to be activated.

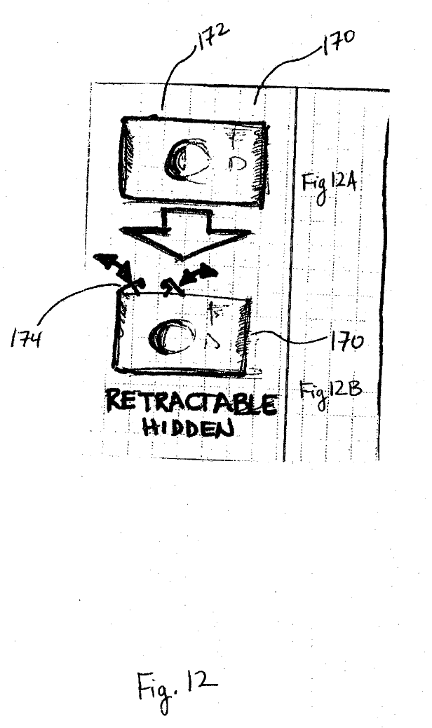

FIG. 12A depicts camera (170) having hidden retractable attachment units (174) that flip out to receive a timer. When the attachment units are folded in they are flush with the top of the camera housing (172).

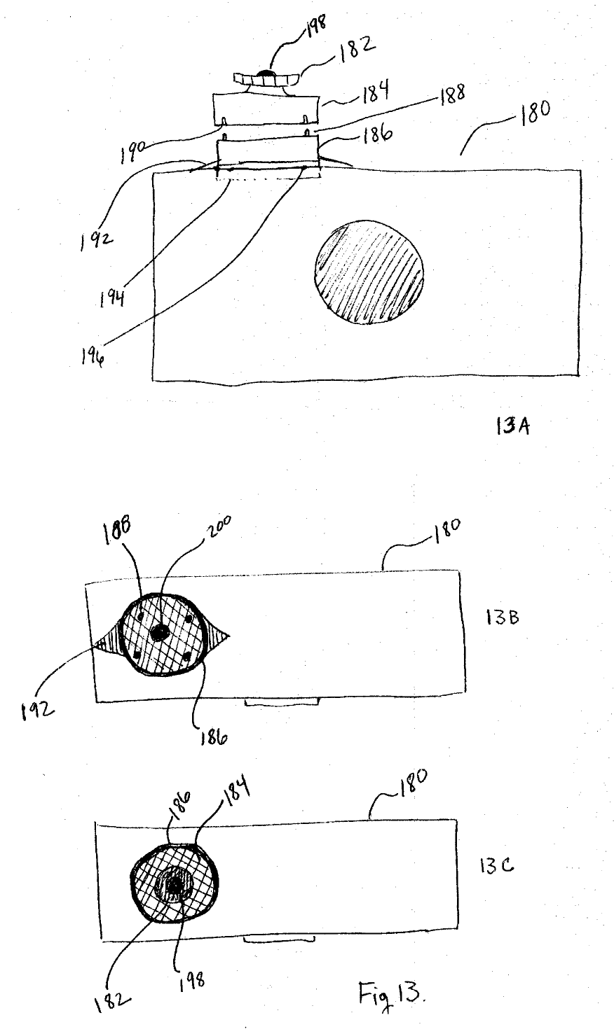

FIG. 13 depicts camera (180) having a base unit (186) for receiving the timer (182). In FIG. 13A the timer (182) sits in its own housing (184) having locking or attaching units (190) for attaching to the timer base (186). The timer base (186) is attached to the camera (180) by attachments (192) having contact points (196) with the camera (180). Optionally the timer base (186) can sit in a well in the camera (194) for stabilizing the timer unit onto the camera base. FIG. 13B depicts a top view of camera (180) with just the timer base (186) attached either removably or permanently at contact and attachment points (192). Locking and attaching units (188) are present on the top of the base for receiving the timer. Within the base is the shutter button or trigger (200) that is surrounded by the timer base for facilitating direct contact of the activation pin with the shutter button (200) upon release of the activation pin. FIG. 13C depicts the camera (180) from a top view now having the timer (184) attached to the timer base (186). Now the shutter button is occluded by the timer (182) that has its own button (198) for activation of the wind-up function of the timer (182). Below the timer button (198) is the shutter button.

The timer device comprises a durable, reusable unit having a timer that unwinds and initiates the device trigger activation, which in many cases, for example, is a camera shutter movement. The device can be, for example, a camera, a single lens reflex camera without an automatic timer, a disposable camera, a single use camera, a standard film camera, a digital camera, or a VCR.

The timer can have a mechanical spring-operated function. It can wind up in a horizontal circular motion, or a vertical circular motion. The horizontal vertical motion will be parallel to the plane in which the device trigger sits. The vertical circular motion will be perpendicular to the plane in which the device trigger sits. Once the trigger has been activated, the firing pin that activated it is automatically retracted to allow the camera film to be advanced.

Additional advantages of the timer device are that it can be constructed of lightweight materials and when thus constructed can be transported easily with the types of devices it is used. Where the entire assembly including a tripod, base and timer are taken together, the entire unit constructed of durable but lightweight plastics can weigh less than about 10 oz, preferably less than about 8 oz., optimally less than about 6 oz., and comfortably about 4.5 oz. or less. The final weight of the device will depend largely upon the materials with which the device is made. The timer, when considered alone, without the base or tripod can weigh considerably less than the base and tripod, making it an ultra lightweight attachment for the camera. The timer, base or tripod can be constructed from any material appropriate, including e.g. lightweight plastics, or metals. When just the timer portion of the assembly is used, without the base or tripod, the timer can be strapped to the camera for transport together with the camera until the two are used together.

In general use, when the picture taker is ready for taking a shot using the hands free activation of the camera shutter, the timer is strapped or otherwise specifically attached over the camera trigger button, the mechanical unit is wound to the appropriate rotation, the camera is positioned for the shot (e.g. on a ledge or wall), and button of the mechanical unit is depressed which activates the rotation cycle, and the person places themselves in the picture just before the shot it taken. The button depresses the pin, the pinhead contacts the trigger button of the camera, and the camera shutter is activated. The pinhead is retracted by the mechanical unit thus providing the opportunity to advance the film for the next shot.

With regard to the other ways to attach the timer to a camera or other device, FIGS. 8-12 are illustrative. The tracks or other components for attaching the timer can be affixed (e.g. by adhesive or other adhering means) to the camera housing for the purpose of receiving the timer device. Alternatively, the camera can be built with these attachments integrated into the housing. Thus, the attachments depicted in FIGS. 8-12, a track as in FIG. 8, a pivoting bar and well as in FIG. 9, a thread-on receiving unit as in FIG. 10, a slide-on track or trough as in FIG. 11 and finally a retractable or hidden attachment unit for attaching to a timer, FIG. 12, are contemplated by the inventors. These attachment scenarios can be part of the camera box built to provide these attachments and to be used with a compatible timer that attaches accordingly. Alternatively, some of these attachments can be added to (e.g. by glue or other adherents) a camera box in order to be able to use a particular timer (e.g. a timer with runners to attach in the trough, see FIG. 11).

Generally then, the timer can, alternative to the other more specific embodiments of FIGS. 8-12, have its own base that affixes on to the camera box and is centered on and over the shutter button. The timer base (186) can provide the timer (182) with a foolproof way to become centered over and stay centered over the shutter button. Accordingly, the activation pin then always hits its mark. The timer (182) can be temporarily attached to the timer base (186) while the timer is in use. After use, the timer (182) can be removed but the base can stay in place in order to be ready for future hands free shots. The base then necessarily does not interfere with manual use of the camera shutter button. Alternatively, the timer base can be removable from the camera also. The base acts to easily and properly align the timer over the shutter button so that during hands free activation the activation pin will hit the shutter button (trigger) with fidelity. The timer base can be affixed to the camera frame in all the ways described in the figures for attaching the entire timer, see e.g. Velcro™ and strap attachments and the attachments described in FIGS. 8-12.

The foregoing is considered as illustrative of the principles of the invention. Since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A timer for hands-free activation of a device having a trigger that otherwise requires manual activation comprising:
d. a mechanical unit connected to a spring, said unit having a rotation cycle that compresses said spring generating a rotational potential,
e. an activation pin in said mechanical unit for receiving said rotational potential and translating said potential into a vertical movement of said pin to strike said trigger on said device upon completion of said rotation cycle, and
f. an attachment modality for temporary attachment of the timer to a portion of said device comprising said trigger so that a pin end rests above said trigger prior to completion of said rotation cycle.

2. A timer as in claim 1, wherein said rotation cycle of said mechanical unit comprises a cycle comprising from about 30 to about 1000 degrees rotation.

3. A timer as in claim 1, wherein said rotation cycle of said mechanical unit comprises a cycle comprising from about 50 to about 500 degrees rotation.

4. A timer as in claim 1, wherein said rotation cycle of said mechanical unit comprises a cycle comprising from about 60 to about 360 degrees rotation.

5. A timer as in claim 1, wherein said rotation cycle of said mechanical unit comprises an adjustable cycle selectable for a variable amount of time comprising an amount of rotational degrees less than 1000 that corresponds to a desired length of time before a trigger activation.

6. A timer as in claim 1, wherein said rotation cycle of said mechanical unit comprises a cycle that comprises a time in a range from about 30 seconds to about 10 minutes.

7. A timer as in claim 5, wherein said variable amount of time comprises a time in a range from about 30 seconds to about 10 minutes.

8. A timer as in claim 1, wherein the device comprises one selected from the group consisting of a camera, a single lens reflex camera without an automatic timer, a disposable camera, a single use camera, a standard film camera, a digital camera, and a VCR.

9. A timer as in claim 1, wherein the attachment modality comprises one selected from the group consisting of tape, Velcro™, a strap comprising a Velcro™ portion, a string, a clasp, a clamp, and a snap-in connection piece.

10. A timer as in claim 1, wherein said mechanical unit having a rotation cycle rotates in a plane parallel to a plane of the device having the trigger.

11. A timer as in claim 1, wherein said mechanical unit having a rotation cycle rotates in a plane perpendicular to a plane of the device having the trigger.

12. A timer as in claim 1, wherein said mechanical unit having a rotation cycle rotates in a plane perpendicular to a plane of vertical movement of the pin.

13. A timer as in claim 1, wherein said mechanical unit having a rotation cycle rotates in a plane parallel to a plane of vertical movement of the pin.

14. A timer as in claim 1, further comprising a planar base to receive said device having a trigger.

15. A timer as in claim 14, wherein said planar base comprises a high friction material that contacts a bottom of said device.

16. A timer as in claim 15, wherein an under portion of said planar base comprises a receiving unit for a tripod.

17. A timer as in claim 14, wherein said planar base comprises wing-like cut-out attachment portions for strapping said timer to said device with tape or straps comprising Velcro™ attachment.

18. A timer for hands-free activation of a device having a trigger that otherwise requires manual activation comprising:
d. a mechanical unit connected to a spring, said unit having a rotation cycle in a range from about 30 to about 1000 rotation degrees that compresses said spring generating a rotational potential,
e. an activation pin in said mechanical unit for receiving said rotational potential and translating said potential into a vertical movement of said pin to strike said trigger on said device with a pin end upon completion of said rotation cycle, and
f. Velcro™ attachment straps for temporary attachment of said timer to a portion of said device so that said pin end rests just above said trigger prior to completion of said rotation cycle.
wherein said rotation cycle of said mechanical unit rotates in a plane parallel to a plane of the device having the trigger.

19. A timer for hands-free activation of a device having a trigger that otherwise requires manual activation comprising:
d. a mechanical unit connected to a spring, said unit having a rotation cycle in a range from about 30 to about 1000 rotation degrees that compresses said spring generating a rotational potential,
e. an activation pin in said mechanical unit for receiving said rotational potential and translating said potential into a vertical movement of said pin to strike said trigger on said device with a pin end upon completion of said rotation cycle, and
f. Velcro™ attachment straps for temporary attachment of the timer to a portion of said device so that said pin end rests just above said trigger prior to completion of said rotation cycle.
wherein said rotation cycle of said mechanical unit rotates in a plane perpendicular to a plane of the device having the trigger.

20. A timer as in claim 18, further comprising a planar base having a high friction surface for receiving said device and providing wing-like cut-out attachment portions for strapping the device, timer and base together.

21. A timer as in claim 19, further comprising a planar base having a high friction surface for receiving said device and providing wing-like cut-out attachment portions for strapping the device, timer and base together.

22. A timer as in claim 20 or 21, wherein an under portion of said planar base comprises a receiving unit for a tripod.

23. A timer as in claim 1, wherein said attachment modality comprises a base unit attached below said mechanical unit, said base unit having a top, a bottom, and an open center, an end of said activation pin at rest in the center of said base unit, said base unit further comprising an attachment selected from the group consisting of a Velcro™ strap passing through said base unit, a strap passing through said base unit, one or more snap-on connections at the bottom of said base unit for snapping to a snapping partner on a camera frame, a clamp-on connection for clamping to said camera frame, and an adhesive portion connected to the bottom of said base unit for adhering to a camera frame; said base unit also comprising attachment on the top of said base unit for attaching said base unit to said mechanical unit, wherein said base unit is placed over said camera trigger with said center over said trigger and said mechanical unit is placed over said base unit attaching to the top.

24. A camera and timer combination comprising a camera having a housing with a top and a bottom, said top having a shutter trigger, wherein said top of said housing comprises a snap-on or clamp-on connection; comprising also a timer having a top and a bottom, said top having a mechanical unit for hands free activation of a camera shutter trigger, said bottom comprising a partner for said snap-on or clamp-on connection on said camera.

25. A timer for hands-free activation of a device having a trigger that otherwise requires manual activation comprising:
d. a mechanical unit connected to a spring, said unit having a rotation cycle that compresses said spring generating a rotational potential,
e. an activation pin in said mechanical unit for receiving said rotational potential and translating said potential into a vertical movement of said pin to strike said trigger on said device upon completion of said rotation cycle, and
f. a base unit having an attachment modality for temporary attachment of the timer to a portion of said device comprising said trigger so that a pin end rests above said trigger prior to completion of said rotation cycle, wherein said base unit is attachable to said mechanical unit and receives said pin.

26. A timer as in claim 25, wherein said base unit is permanently attached to said mechanical unit.
